(19) United States
(12) Patent Application Publication
(10) Pub. No.: US 2026/0266105 A1
(43) Pub. Date: Sep. 10, 2026

(54) VEHICLE DOOR LATCH

(71) Applicant: Minebea AccessSolutions France, Alfortville (FR)

(72) Inventors: François DEBROUCKE, Alfortville (FR); Robin DUVAUCHELLE, Alfortville (FR); Aurélie SZALAI, Alfortville (FR)

(73) Assignee: Minebea AccessSolutions France, Alfortville (FR)

(21) Appl. No.: 19/552,114

(22) Filed: Feb. 27, 2026

(30) Foreign Application Priority Data
Mar. 4, 2025 (EP) 25315072

(51) Int. Cl. E05B 81/20; E05B 79/02; E05B 81/06; E05B 81/56

(52) U.S. Cl. CPC E05B 81/20; E05B 79/02; E05B 81/06; E05B 81/56

(57) ABSTRACT

A door latch, particularly for a motor vehicle, includes a first part including a housing, a retention unit for engaging with a striker in a closed position and releasing the striker in an opened position, and an electrical actuation group to drive the retention unit to its opened position. The retention unit and the electrical actuation group are arranged at least partially within the housing. The door latch also includes a second removable part to be assembled to the first part. The second removable part also includes an electronic control circuit to control the retention unit and/or the electrical actuation group for opening or closing the door latch, such that the door latch becomes an electrical latch.

### TECHNICAL FIELD

The present invention relates to the field of vehicle door latches to ensure the closing of vehicle doors.

### BACKGROUND OF THE INVENTION

Conventional door latches have a release system which is purely mechanical. End user directly activates a mechanical opening control that moves a cable which release a door latch of the door enabling the door to open.

A door latch generally comprises a retention unit configured for selectively engaging with a striker on the vehicle body or disengaging from the striker, to latch or unlatch the door.

Nowadays, vehicles are more and more equipped with an electrical latch (commonly known as e-latch) or with vehicle door latches comprising an electrical release mechanism, also called E-release mechanism.

E-latches are provided for electrically controlling the opening and the closing of the vehicle doors, while E-release mechanisms enable to open the door by a simple move such as a pressure on a switch or a movement in front of a detector.

In the process of electrically opening the latch, the retention unit, generally including a pawl that retains a claw, is driven by an electrical motor in an opened position allowing the pawl to free the claw. As soon as it is no longer retained by the pawl, the claw can pivot to release the striker.

In case of an E-release mechanism, the latch can be a slave of an external electronic for driving the electrical motor.

On the contrary, an E-latch further includes an electronic control circuit, such as a printed circuit board knows as PCB, for example including a microcontroller or other known computing unit, coupled to the electrical motor and providing driving signals thereto. Such electronic control circuit is conveniently embedded in a housing of the E-latch. The electronic control circuit is usually electrically coupled to a vehicle main management unit, which is configured to control general operation of the motor vehicle. Such electronic control circuit is generally also coupled to one or more sensors of the vehicle, such as sensors, configured to detect the operating position, for example of the claw and/or pawl.

The door latch with an E-release mechanism does not include such electronic control circuit and is thus a different concept from the E-latch. The door latch with an E-release mechanism and the E-latch are of different designs, and it is not possible to switch from one to the other easily.

One aim of the present invention is to provide a door latch that can be adapted between a latch with E-release mechanism and an E-latch.

### SUMMARY OF THE INVENTION

The present invention refers to a door latch, particularly for a motor vehicle, comprising a first part including a housing, a retention unit configured for engaging with a striker in a closed position and releasing the striker in an opened position and an electrical actuation group configured to drive the retention unit to its opened position, the retention unit and the electrical actuation group being arranged at least partially within the housing.

According to the invention, the door latch further comprises a second removable part, configured to be assembled to the first part and comprising an electronic control circuit, the electronic control circuit being configured to control the retention unit and/or the electrical actuation group for opening or closing the door latch, such that the door latch becomes an electrical latch.

Such a solution allows to propose a range of products only by adding or removing the electronic control circuit without re-designing a complete product. The E-release latch can receive the electronic control circuit extension to become an E-latch.

The door latch may further include one or more of the following features taken alone or in combination.

The second part may include a case configured to be fixed to the housing of the first part. For instance, the case may be configured to be snapped or plugged onto the housing of the first part.

The door latch may comprise complementary fixation means carried on the case and the housing.

The case and the housing may have a similar thickness.

The case may comprise side arms, protruding out of a space receiving the electronic control circuit, and configured to frame and to be fixed on a portion of the housing, when the first part and the second part are assembled.

The housing of the first part may include a dedicated cavity configured to receive at least partially the electronic control circuit.

The housing may include a first cavity receiving at least one component of the first part.

The housing may include a second cavity configured to receive the electronic control circuit.

The second cavity may be adjacent to the first cavity.

The electrical actuation group may comprise an electrical motor.

The electrical actuation group may comprise an electrical gear wheel configured to be driven by said motor.

The electronic control circuit may be configured to be electrically coupled to the electrical motor when the first part and the second part are assembled.

The electronic control circuit may be configured to provide driving signals to the electrical motor.

The electronic control circuit may include at least one electrical and/or electronical component, and a connector configured to be linked to a power supply of the electrical to supply electrical energy to the at least one electrical and/or electronical component of the electronic control circuit.

The electronic control circuit may be unique for a left-handed door latch or a right-handed door latch.

The door latch may comprise a cover arranged around the first part and the second part, when assembled.

### BRIEF DESCRIPTION OF THE DRAWINGS

FIG. 1 is a perspective view of an embodiment of an electrical door latch with a housing receiving an electrical release mechanism and an electronic control circuit snapped onto the housing.

FIG. 2a shows steps for assembling the housing receiving the electrical release mechanism and the electronic control circuit to obtain the electrical door latch of FIG. 1.

FIG. 2b shows steps for assembling the electronic control circuit into the housing receiving the electrical release mechanism to obtain an electrical door latch according to another embodiment.

FIG. 3 shows steps for assembling the electronic control circuit into the housing receiving the electrical release mechanism to obtain a right-handed or left-handed door latch.

FIG. 4 shows steps for assembling the electrical door latch of FIG. 1 with a cover.

In these figures, the identical elements have the same reference numbers. Only the elements necessary for the understanding of the invention are shown.

### DETAILED DESCRIPTION OF THE INVENTION

The following embodiments are examples. Although, the specification refers to one or several embodiments, it does not imply that each reference refers to the same embodiment or that the features apply only to a single embodiment. Simple features of different embodiments can also be combined to provide other embodiments, without departing from the scope of the invention, as defined by the claims.

In the description, some elements may be indexed, for example first element or second element. In this case, it is a simple indexing to differentiate and name similar but not identical elements. This indexing does not imply a priority of one element over another and such names can easily be interchanged without going beyond the scope of the present invention.

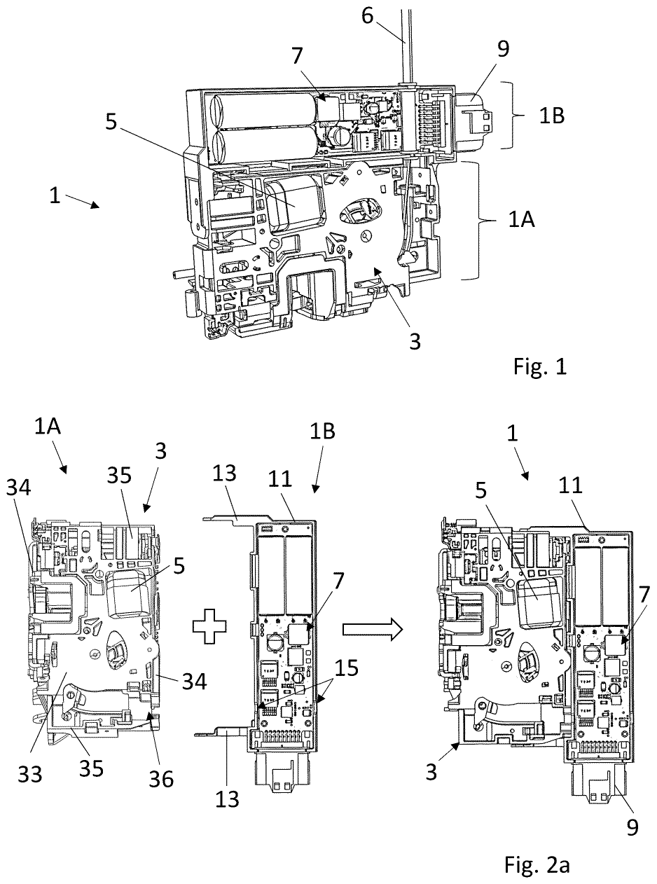

Referring to FIG. 1, the present invention refers to a door latch 1. The door latch 1 is configured to ensure the closing of a door of a vehicle, particularly of a motor vehicle.

In the following, the term “door” is used in its widest sense to indicate any member movable between an open and a closed position to open and close an access opening to an internal compartment of a vehicle, and therefore includes hoods and rear doors, trunks, or front trunks, also known as “frunks”, in addition to the vehicle side doors.

The door latch 1 includes a first part 1A and a second part 1B that can be assembled with or disassembled from the first part 1A. The second part 1B is thus a removable part.

Referring to the orientation of FIG. 1, the second part 1B may be mounted on top of the first part 1A. It is preferably not added on a lateral side of the first part 1A which would add thickness to the assembly.

The door latch 1 can be provided at least with an electrical release (hereinafter E-release) mechanism or can be adapted to an electrical latch (hereinafter E-latch) by removing or adding the second part 1B onto the first part 1A. The door latch 1 comprising only the first part 1A enables to carry out E-release functions. The assembly comprising both the first part 1A and the second part 1B coupled together, forms an E-latch.

### First Part 1A

The first part 1A of the door latch 1 comprises a housing 3. The housing 3 may receive one or more components of the door latch 1.

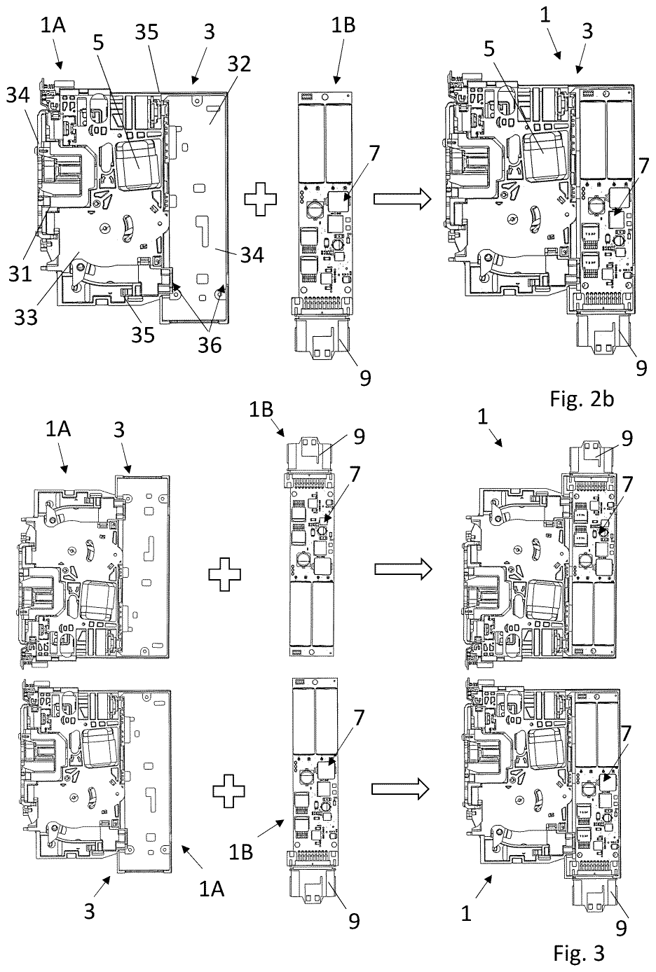

According to a first embodiment, the housing 3 can be shaped to receive only components of the first part 1A (FIG. 1 and FIG. 2a).

According to a second embodiment, the housing 3 can be designed to also receive at least one component of the second part 1B (FIG. 2b) as will be described later. For that purpose, the housing 3 may include a first cavity 31 receiving the components of the first part 1A and a second cavity 32 that may be configured to receive at least one component of the second part 1B. The second cavity 32 may be adjacent to the first cavity 31.

As an example, the housing 3 may be in a general shape of a parallelepiped, with two main opposite faces 33, joined by two opposite longitudinal faces 34 and two opposite lateral faces 35.

The door latch 1 usually comprises a retention unit that may include a claw and a pawl (not visible in the figures). The retention unit is for instance provided in the first part 1A of the door latch 1.

The retention unit is arranged at least partially inside the housing 3 and is covered by the latter in the figures. The claw and the pawl are both configured to move, in particular to pivot, at least between an opened position and a closed position. In the closed position, the retention unit can engage with a striker (not represented) of the vehicle. In the opened position, the retention unit can release the striker to release the door latch 1. The pawl may allow the rotation of the claw, and the rotation of the claw releases the striker so the door can be opened.

The door latch 1 also comprises an electrical actuation group with at least an electrical motor 5. The electrical actuation group may also comprise an electrical gear wheel (not shown) that is configured to be moved by the electrical motor 5, thus electrically, from a rest position to an opening position. The rotation of the electrical gear wheel may be configured to move an opening lever of the door latch 1, to a position leading to the release of the door latch 1.

The electrical motor 5 is intended to be electrically connected to an electric power supply of the vehicle.

The electrical motor 5 may be activated by a control unit of the door latch 1 when a user activates an electrical (or electronical) opening control, such as a switch of a door or a key, or a movement in front of a detector.

The electrical motor 5, and possibly the electrical gear wheel, may be parts of the E-release mechanism of the door latch 1. The E-release mechanism is provided in the first part 1A of the door latch 1.

The door latch 1, more particularly the first part 1A, may further comprise a mechanical release mechanism, that may include at least one release lever. The release lever may be moved by a mechanical opening control of the vehicle door, such as an inside handle, from the inside of the vehicle, or an outside handle. For that purpose, the release lever may be mechanically linked to the mechanical opening control (handle), for example by a cable or by a rod 6. This cable/rod 6 can be pulled by a user activating the mechanical opening control.

The housing 3 may include a passage 36 for the cable/rod 6 connecting the release lever to the mechanical opening control such as the handle. When the housing 3 is designed with a cavity 32 for receiving the second part 1B, the passage 36 for the cable/rod 6 may be provided on a wall between the first and second cavities 31, 32 and on an outer wall delimitating the second cavity 32.

### Second Part 1B

The second part 1B of the door latch 1 comprises at least an electronic control circuit 7, such as a printed circuit board (PCB). The electronic control circuit 7 includes one or more electrical or electronical components enabling to carry out electrical functions, such as locking/unlocking, E-release functions of the vehicle door.

The components of the electronic control circuit 7 may be protected thanks to a resin added on.

As an example, the electronic control circuit 7 may include a control unit, for example provided with a microcontroller, microprocessor or other known analogous computing unit. The electronic control circuit 7 may also comprise switches. The electronic control circuit 7 may comprise a memory for storing any suitable programs and computer instructions. A memory may also be provided for instance for storing a status/position of the latch 1. The electronic control circuit 7 may also comprise and/or be coupled to one or more sensors.

The electronic control circuit 7 may further comprise a connector 9 configured to be linked to an electric power supply. The power supply can be a main electric power supply of the vehicle (for example to the 12V battery of the vehicle). As an alternative, it can be a secondary battery dedicated to supply electrical equipments of the vehicle such as the electrical door latch 1.

The electric power supply is configured to supply electrical energy to the one or more components of the electronic control circuit 7.

When the second part 1B is assembled with the first part 1A, the electronic control circuit 7 may be electrically coupled to the electrical motor 5, for instance through corresponding terminals, and may provide driving signals thereto.

The pawl can selectively engage the claw to prevent it from rotating, driven by the electrical motor 5, to move between the closed position and the opened position. The electronic control circuit 7 can control the actuation of the door.

### First Embodiment

According to a first embodiment (FIG. 2a), the electronic control circuit 7 is embedded in a different box or case 11 than the housing 3 of the first part 1A.

In other words, the electronic control circuit 7 comes with its own case 11. The electronic control circuit 7 with its own case 11, forms a complete unit, that can be added on the first part 1A.

This case 11 is configured to be fixed to the first part 1A, namely to the housing 3. To this end, complementary fixation means can be carried by both the case 11 and the housing 3. For instance, the case 11 may be plugged or snapped onto the housing 3. As an alternative or in combination, the case 11 may be screwed with the housing 3.

As illustrated, the case 11 may be arranged on a longitudinal face 34 of the housing 3, when parallelepiped shaped.

As an example, the case 11 may have two opposite side arms 13, protruding out of the space receiving the electronic control circuit 7, and able to slide and possibly to snap onto the housing 3, for instance at the lateral faces 35 of the housing 3 when parallelepiped shaped. The case 11 thus frames a portion of the housing 3.

The case 11 may be of the same or similar thickness than the housing 3. Therefore, when fixed to the housing 3, the case 11 may form a continuation of the housing 3. The same thickness is thus kept everywhere, such that it is compliant with door environment, contrary to solutions from the state of the art with E-latch having an electronic part usually bigger than the remaining of the latch.

The case 11 may be of a complementary form with the housing 3, such as a general shape of a parallelepiped. It is for example opened on one face, with one main face framed by two opposite longitudinal faces and two opposite lateral faces.

Besides, the case 11 may include a passage for the cable or rod 6 connecting the release lever of the first part 1A to the mechanical opening control such as a handle. The passage for the cable/rod 6 may be formed by two opposite through-holes 15.

The connector 9 may protrude out of the case 11, more precisely from one lateral face. When both parts 1A, 1B are assembled, the connector 9 may be arranged at an edge of the obtained door latch 1.

### Second Embodiment

According to a second embodiment (FIG. 2b), the electronic control circuit 7 is configured to be arranged in the same housing 3 of the first part 1A. For that purpose, the housing 3 may include a first cavity 31 receiving the components of the first part 1A and a second cavity 32 configured to receive the electronic control circuit 7.

The electronic control circuit 7 may be electrically coupled to a vehicle main management unit, which may be configured to control general operation of the motor vehicle, to exchange signals, data, commands and/or information.

Furthermore, a same second part 1B, according to the first or the second embodiment, can be used for a right-handed or a left-handed door latch 1. To this end, only the way of integrating the second part 1B to the first part 1A changes.

Referring to FIG. 3, the second part 1B is configured to be used in either a left-handed or a right-handed door latch by simply rotating the first part 1A and the second part 1B of 180° each, about a central axis for each one. The central axis is transverse to the plane of the sheet.

In reference to the particular orientation of FIG. 3, in one case the connector 9 is oriented upwards and in the other case the connector 9 is oriented downwards.

FIG. 3 shows the housing 3 of the first part 1A when designed to receive the second part 1B (second embodiment). However, this adaptation feature to both left-handed and right-handed door latch also applies to the housing 3 on which is fixed the case 11 of the second part 1B (first embodiment).

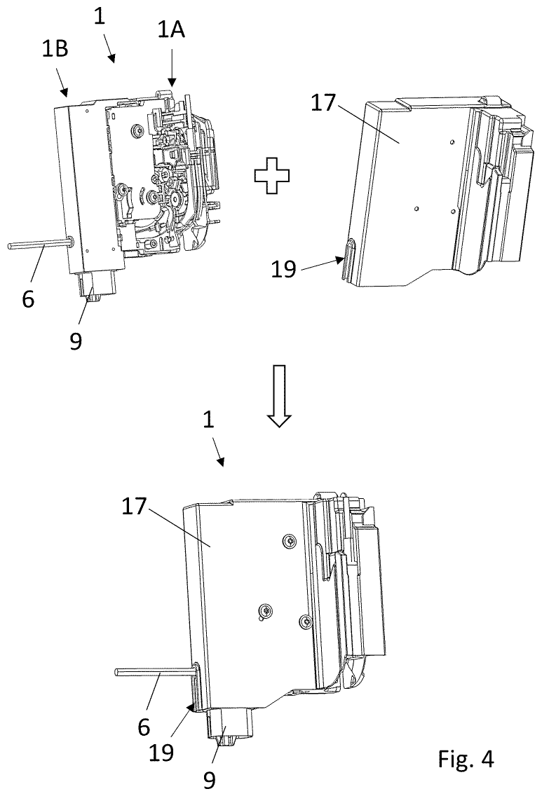

Referring to FIG. 4, a cover 17 may be arranged around the housing 3, and possibly the case 11, to protect the door latch 1 from water and/or dust. The cover 17 is complementary in shape to the assembly of the first part 1A and the second part 1B, according to the first or second embodiment.

The cover 17 may include a slot 19 through which may extend and move the cable or rod 6 connecting the release lever of the first part 1A to the mechanical opening control such as a handle.

Therefore, the door latch 1 is made to evolve from an E-release latch to an E-latch with an electronic control circuit 7, and inversely.

The first part 1A forms an E-Release latch on which the electronic control circuit 7 of the second part can be added through a dedicated space or cavity 32 in the housing 3 of the first part 1A to receive the electronic control circuit 7 or the electronic control circuit 7 can be added on the first part 1A with its own case 11. The second part 1B can also be removed to downgrade to an E-release latch. Besides, a unique electronic control circuit 7 can be provided whatever the latch is right-handed or left-handed. The whole door latch 1 (both parts 1A, 1B) can further be protected by a cover to make it waterproof and/or dustproof.

1-12. (canceled)

13. A door latch for a motor vehicle, comprising:
a first part including a housing, a retention unit configured for engaging with a striker in a closed position and releasing the striker in an opened position, and an electrical actuation group configured to drive the retention unit to the opened position, the retention unit and the electrical actuation group being arranged at least partially within the housing; and
a second removable part configured to be assembled to the first part and comprising an electronic control circuit, the electronic control circuit being configured to control the retention unit and/or the electrical actuation group to open or close the door latch such that the door latch is an electrical latch.

14. The door latch according to claim 13, wherein the second part includes a case configured to be fixed to the housing of the first part.

15. The door latch according to claim 14, further comprising complementary fixation means carried on the case and the housing.

16. The door latch according to claim 14, wherein the case and the housing have a similar thickness.

17. The door latch according to claim 14, wherein the case comprises side arms protruding out of a space receiving the electronic control circuit, and the side arms are configured to frame and to be fixed on a portion of the housing when the first part and the second part are assembled.

18. The door latch according to claim 13, wherein the housing of the first part includes a dedicated cavity configured to receive at least partially the electronic control circuit.

19. The door latch according to claim 18, wherein the housing includes a first cavity configured to receive at least one component of the first part and a second cavity, adjacent to the first cavity, and configured to receive the electronic control circuit.

20. The door latch according to claim 13, wherein the electrical actuation group comprises an electrical motor.

21. The door latch according to claim 20, wherein the electronic control circuit is configured to be electrically coupled to the electrical motor when the first part and the second part are assembled, and to provide driving signals to the electrical motor.

22. The door latch according to claim 13, wherein the electronic control circuit includes:
at least one electrical and/or electronical component, and
a connector configured to be linked to an electrical power supply to supply electrical energy to the at least one electrical and/or electronical component of the electronic control circuit.

23. The door latch according to claim 13, wherein the electronic control circuit is unique for a left-handed door latch or a right-handed door latch.

24. The door latch according to claim 13, further comprising a cover arranged around the first part and the second part, when assembled.
